(19) United States
(12) Patent Application Publication
(10) Pub. No.: US 2012/0026073 A1
(43) Pub. Date: Feb. 2, 2012

(54) PLASMA DISPLAY APPARATUS

(76) Inventors: Ayahito Kojima, Kanagawa (JP); Takashi Sasaki, Kanagawa (JP)

(21) Appl. No.: 12/739,288

(22) PCT Filed: Apr. 25, 2008
(86) PCT No.: PCT/JP08/01091

§ 371 Date: Apr. 22, 2010

(51) Int. Cl. G09G 3/28

(52) U.S. Cl. 345/60

(57) ABSTRACT

A plasma display device has a plasma display panel (PDP), a first driver circuit, and a first flexible cable. The PDP has a first plate on which a plurality of first and second electrodes extending in a first direction are provided and a second plate facing the first plate via a discharge space. Here, the first driver circuit is a circuit which applies a voltage to the first electrodes. Further, the first flexible cable has one end coupled to the first electrodes in a circumference part of the plasma display panel, and has the other end coupled to the first driver circuit inside a circumference of the plasma display panel without folding back the first flexible cable. Consequently, disconnection between the PDP and the driver circuit can be prevented, and reliability of the PDP device can be improved.

### TECHNICAL FIELD

The present invention relates to a plasma display device.

### BACKGROUND ART

The plasma display device (PDP device) has a plasma display panel (PDP) and a driver unit driving the PDP. The PDP is formed of two glass plates (a front glass plate and a back glass plate) adhered to each other and displays an image by generating a discharge in a space (discharge space) formed between the glass plates. Cells corresponding to pixels in an image are self-luminescence type, and phosphors which emit red, green, and blue visible lights under an ultraviolet ray generated by discharge are applied to the cells.

For example, a PDP having a three-electrode structure displays an image by generating a sustain discharge between an X electrode and a Y electrode. A cell generating the sustain discharge (cell to be lighted) is selected for example by selectively generating an address discharge between the Y electrode and an address electrode.

Further, the driver unit has a driver circuit which applies voltages to the X electrode, the Y electrode and the address electrode. In this type of PDP device, the driver circuit is coupled to each electrode with a flexible board (flexible cable) (see, for example, Patent Document 1). In general, the driver circuit is disposed on a back side of the PDP. Accordingly, the flexible cable extending outward from a circumference part of the PDP is folded back in a U shape to be coupled to the driver circuit.

### Patent Document 1: Japanese Unexamined Patent Application Publication No. 2006-301317

### DISCLOSURE OF THE INVENTION

### Problems to be Solved by the Invention

In the structure in which the flexible cable is folded back, it is possible that the coupling state becomes unstable (a non-coupled state, disconnection) in a connection part of the electrode and the flexible cable due to a force of the flexible cable to turn back to the original shape. In short, in this type of PDP device, disconnection may occur between the PDP and the driver circuit. Further, it is necessary to secure a space for bending the flexible cable gently to prevent the flexible cable itself from being disconnected. Accordingly, the size (thickness, width, and so on) of the PDP device relative to the PDP becomes large, and manufacturing costs increase.

A proposition of the present invention is to prevent disconnection between the PDP and the driver circuit to improve reliability of the PDP device. Further, a proposition of the present invention is to provide a thin PDP device.

### Means for Solving the Problems

A plasma display device has a plasma display panel (PDP), a first driver circuit, and a first flexible cable. The PDP has a first plate on which a plurality of first and second electrodes extending in a first direction are provided and a second plate facing the first plate via a discharge space. Here, the first driver circuit is a circuit which applies a voltage to the first electrodes. Further, the first flexible cable has one end coupled to the first electrodes in a circumference part of the plasma display panel, and has the other end coupled to the first driver circuit inside a circumference of the plasma display panel without folding back the first flexible cable.

### Effects of the Invention

The present invention enables to prevent disconnection between a PDP and a driver circuit, and thus reliability of a PDP device can be improved. Further, the present invention enables to provide a thin PDP device.

### BRIEF DESCRIPTION OF THE DRAWINGS

FIG. 1 is a view showing a PDP device according to an embodiment.

FIG. 2 is a view showing a main part of a PDP shown in FIG. 1.

FIG. 3 is a diagram showing an overview of a circuit unit shown in FIG. 1.

FIG. 4 is a view showing an example of states of flexible cables seen from a side opposite to an image display surface.

FIG. 5 is a view showing an overview of a side face of the PDP device along a first direction seen from a direction opposite to a side where an address driver shown in FIG. 4 is disposed.

FIG. 6 is a view showing an overview of a side face of the PDP device along a second direction seen from a side where a Y driver shown in FIG. 4 is disposed.

FIG. 7 is a view showing an example of a cross section along the first direction in the vicinity of a connection part of a flexible cable for Y electrode and a Y electrode shown in FIG. 5.

FIG. 8 is a view showing an example of a modification of the PDP shown in FIG. 2.

FIG. 9 is a view showing an overview of a side face along the second direction in a PDP device using the PDP shown in FIG. 8.

### BEST MODE FOR CARRYING OUT THE INVENTION

Hereinafter, an embodiment of the present invention will be described using the drawings.

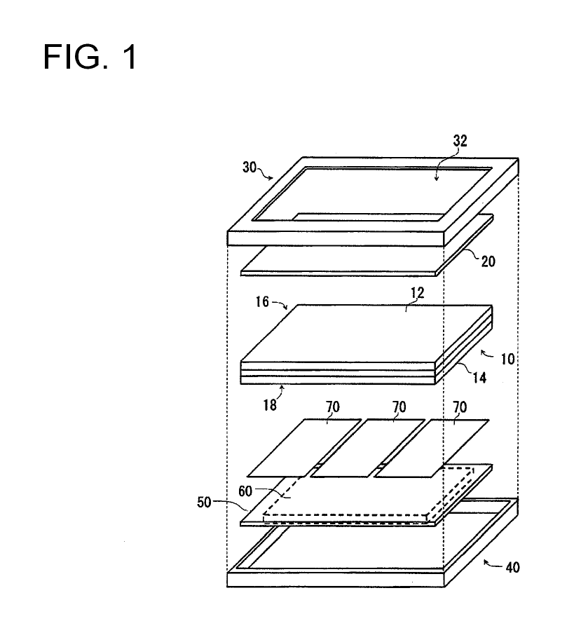

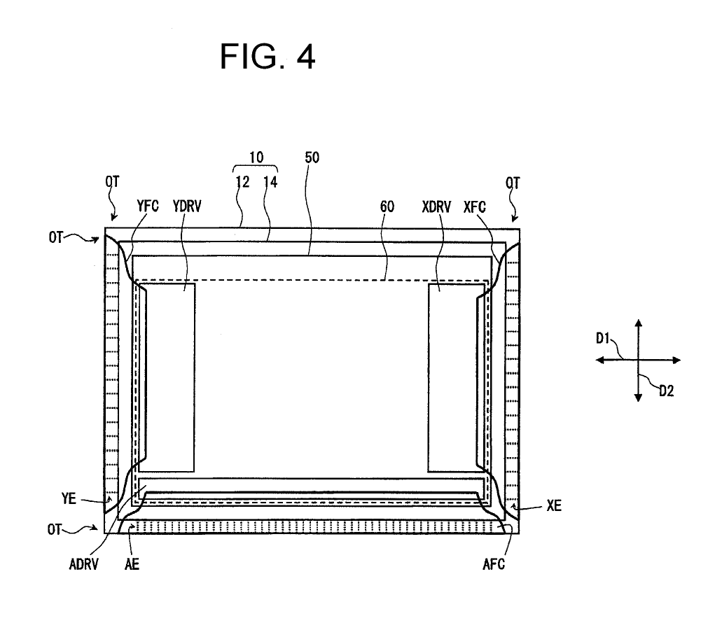

FIG. 1 shows an embodiment of the present invention. A plasma display device (hereinafter also referred to as a PDP device) has a plasma display panel 10 (hereinafter also referred to as PDP) having a quadrangle plate shape, an optical filter 20 provided on the side of an image display surface 16 (light output side) of the PDP 10, a front case 30 disposed on the side of the image display surface 16 of the PDP 10, a rear case 40 and a base chassis 50 disposed on the side of a rear face 18 of the PDP 10, a circuit unit 60 fixed to the side of the rear case 40 of the base chassis 50 for driving the PDP 10, and a double-faced adhesive sheet 70 for adhering the PDP 10 to the base chassis 50. The circuit unit 60 is made up of plural components and therefore illustrated as a dashed line box in the diagram. Incidentally, the circuit unit 60 is coupled electrically to the PDP 10 with not-shown flexible cables (for example, flexible cables XFC, YFC, and AFC shown in FIG. 4 described later).

The PDP 10 is made up of a front plate part 12 (first plate) forming the image display surface 16 and a back plate part 14 (second plate) facing the front plate part 12. Not shown discharge spaces (cells) are formed between the front plate part 12 and the back plate part 14. The front plate part 12 and the back plate part 14 are formed of a glass plate for example. The optical filter 20 is adhered to a protection glass (not shown) fixed to an opening part 32 of the front case 30. Incidentally, the optical filter 20 may have a function to shield against electromagnetic waves. Further, the optical filter 20 may be adhered directly to the side of the image display surface 16 of the PDP 10 instead of the protection glass.

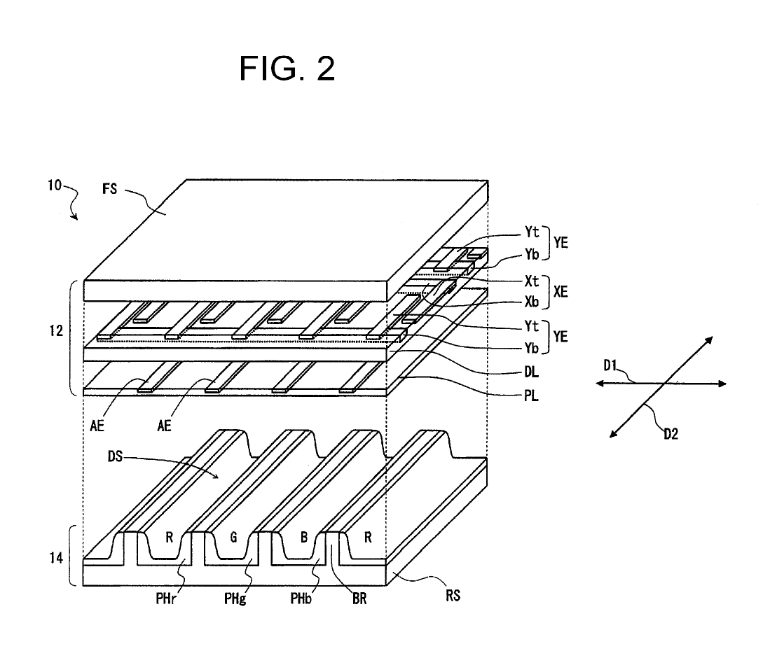

FIG. 2 shows details of a main part of the PDP 10 shown in FIG. 1. An arrow D1 in the diagram denotes a first direction D1, and an arrow D2 denotes a second direction D2 orthogonal to the first direction D1 in a plane parallel to the image display surface. As described above, discharge spaces DS are formed between the front plate part 12 and the back plate part 14 (more specifically, in a dent part of the back plate part 14).

The front plate part 12 has a plurality of X bus electrodes Xb and Y bus electrodes Yb, which are provided to extend in the first direction D1 on a plane (lower side in the view) of a glass base FS that faces a glass base RS and disposed at intervals from each other. Further, X transparent electrodes Xt extending in the second direction D2 from the X bus electrodes Xb to the Y bus electrodes Yb are coupled to the X bus electrodes Xb. Y transparent electrodes Yt extending in the second direction D2 from the Y bus electrodes Yb to the X bus electrodes Xb are coupled to the Y bus electrodes Yb. In the shown example, the X transparent electrodes Xt and the Y transparent electrodes Yt are facing each other along the second direction D2.

For example, the X bus electrodes Xb and the Y bus electrodes Yb are opaque electrodes formed of a metal material or the like, and the X transparent electrodes Xt and the Y transparent electrodes Yt are transparent electrodes transmitting a visible light, which are formed of an ITO film or the like. X electrodes XE (second electrodes (or first electrodes), sustain electrodes) are formed of the X bus electrodes Xb and the X transparent electrodes Xt, and Y electrodes YE (first electrodes (or second electrodes), scan electrodes) are formed of the Y bus electrodes Yb and the Y transparent electrodes Yt and are paired with the X electrodes XE. A discharge (sustain discharge) is generated repeatedly between the X electrodes XE and the Y electrodes YE (more specifically, between the X transparent electrodes Xt and the Y transparent electrodes Yt) which are paired with each other.

Incidentally, the transparent electrodes Xt and Yt may be disposed on the entire surface between the glass base FS and the bus electrodes Xb and Yb to which the transparent electrodes Xt and Yt are coupled respectively. Further, the electrodes integrated with the bus electrodes Xb and Yb may be formed instead of the transparent electrodes Xt and Yt with the same material (metal material or the like) as the bus electrodes Xb and Yb

The electrodes Xb, Xt, Yb, and Yt are covered with a dielectric layer DL. For example, the dielectric layer DL is an insulating film of a silicon dioxide film or the like formed by a CVD method. On the dielectric layer DL (on a lower side in the view), a plurality of address electrodes AE (third electrodes) extending in a direction orthogonal to the bus electrodes Xb, Yb (second direction D2) are provided. Thus, in the PDP in this embodiment, the electrodes XE, YE extending in the first direction D1 and the address electrodes AE extending in the second direction D2 are provided on the front plate part 12.

The address electrodes AE and the dielectric layer DL are covered with a protective layer PL. For example, the protective layer PL is formed of an MgO film with a high emission characteristic of secondary electrons due to collision of positive ions, so that the discharge can be generated easily.

The back plate part 14 facing the front plate part 12 via the discharge spaces DS has barrier ribs (barrier ribs) BR formed in parallel with each other on the glass base RS and extending in the direction orthogonal to the bus electrodes Xb, Yb (second direction D2). That is, the barrier ribs BR are provided on a plane of the glass base RS that faces the glass base FS, extend in the second direction D2 intersecting the first direction D1, and are disposed at intervals. The barrier ribs BR form side walls of the cells. Moreover, phosphors PHr, PHg, and PHb emitting visible lights of red (R), green (G), and blue (B) as a result of being excited by an ultraviolet ray are applied on side faces of the barrier ribs BR and on the glass base RS between the barrier ribs BR adjacent to each other.

One pixel of the PDP 10 is made up of three cells emitting red, green and blue lights. Here, one cell (pixel with one color) is formed of a region surrounded by bus electrodes Xb, Yb and barrier ribs BR. Thus, the PDP 10 is structured by arranging cells for displaying an image in a matrix form, and alternately arranging several types of cells emitting lights of different colors from each other. Although not shown particularly, the cells formed along the bus electrodes Xb, Yb make up display lines.

The PDP 10 is formed by adhering the front plate part 12 and the back plate part 14 to each other so that the protective layer PL and the barrier ribs BR contact each other, and encapsulating a discharge gas such as Ne, Xe, or the like in the discharge spaces DS.

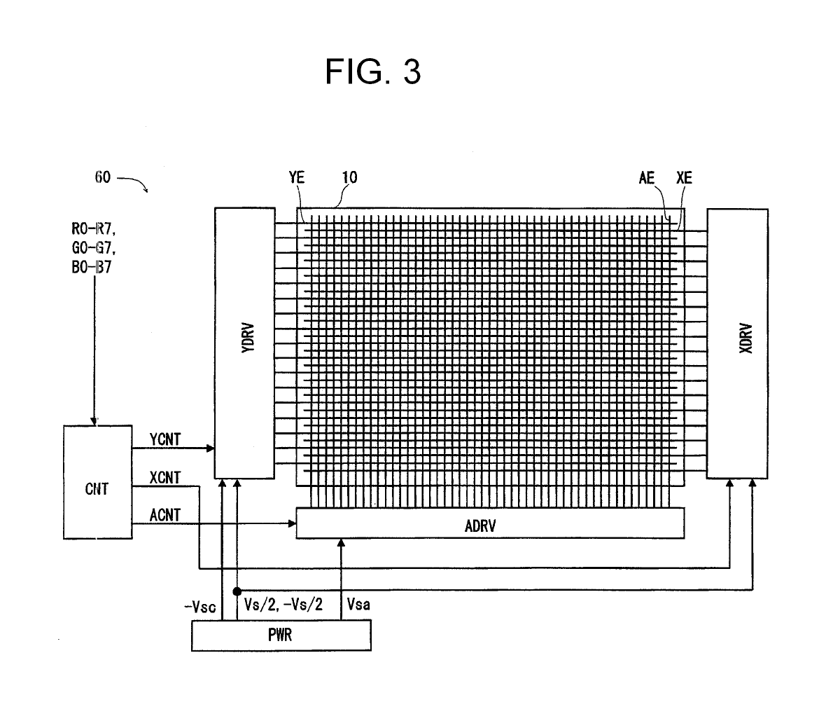

FIG. 3 shows an overview of the circuit unit 60 shown in FIG. 1. The circuit unit 60 has a control unit CNT, an X driver XDRV (second driver circuit (or first driver circuit)), a Y driver YDRV (first driver circuit (or second driver circuit)), an address driver ADRV (third driver circuit) and a power supply unit PWR. The power supply unit PWR generates power supply voltages −Vsc, Vs/2, −Vs/2, and Vsa, and so on to be supplied to the drivers YDRV, XDRV, and ADRV.

The control unit CNT controls operations of the drivers XDRV, YDRV, and ADRV. For example, the control unit CNT selects subfields to be used based on image data R0-7, G0-7, B0-7, and outputs control signals YCNT, XCNT, and ACNT to the drivers YDRV, XDRV, and ADRV. Here, subfields are fields divided from one field for displaying one screen of the PDP 10, and the number of times of sustain discharge is set for each subfield. By selecting subfields to be used for every cell forming a pixel, an image with multiple gradations is displayed. For example, a subfield is formed including an address period to select a cell to be lighted (cell in which the sustain discharge is generated), a sustain period to generate the sustain discharge in the cell selected in the address period, and the like.

In this embodiment, the drivers XDRV, YDRV, and ADRV are electrically coupled to the electrodes XE, YE, and AE, respectively, with flexible cables XFC, YFC, and AFC shown in FIG. 4 described later. The drivers XDRV, YDRV, and ADRV operate as a driver unit to drive the PDP 10.

For example, the X driver XDRV applies the voltages −Vs/2, Vs/2 (negative and positive sustain pulses) to the X electrodes XE alternately in the sustain period. Further, the Y driver YDRV applies the voltages Vs/2, −Vs/2 (positive and negative sustain pulses), having polarities different from the voltages applied to the X electrodes XE, to the Y electrodes YE alternately in the sustain period, and applies the voltage −Vsc (scan pulse) to the Y electrodes YE selectively in the address period. The address driver ADRV applies the voltage Vsa (address pulse) to the address electrodes AE selectively in the address period.

In a cell selected by the scan pulse and the address pulse, a discharge (address discharge) is generated temporarily between the Y electrode YE and the address electrode AE. Thus, in the address period, a cell to be lighted in the sustain period is selected. Further, in the sustain period, the sustain pulses having different polarities from each other are applied repeatedly to the X electrodes XE and the Y electrodes YE, thereby performing a discharge (sustain discharge) repeatedly in the cell lighted in the sustain period.

FIG. 4 shows an example of states of flexible cables XFC, YFC, and AFC seen from a side (lower side in FIG. 1) opposite to the image display surface. Arrows in the view have the same meaning as in FIG. 2 described above. Incidentally, in FIG. 4, illustrations of the optical filter 20, the front case 30, the rear case 40, and so on shown in FIG. 1 described above are omitted. Now, for example, a flexible cable YFC for Y electrode (first (or second) flexible cable), a flexible cable XFC for X electrode (second (or first) flexible cable) and a flexible cable AFC for address electrode (third flexible cable) are deformable wires, which are wires of metal material formed on a base film and each have a wiring portion except a connection part to be coupled to another component or the like being covered with a protective film.

The circuit unit 60 is fixed to a back side (the rear case 40 side shown in FIG. 1 described above) of the base chassis 50 inside edge parts of the back plate part 14, and the edge parts of the back plate part 14 are located more inside than edge parts of the front plate part 12. For example, the Y electrodes YE are drawn out to the vicinity of an edge part (the circumference part OT on a left side in FIG. 4) along the second direction D2 of the front plate part 12, and the X electrodes XE are drawn out to the vicinity of an edge part (the circumference part OT on a right side in FIG. 4) opposite to the edge part of the front plate part 12 to which the Y electrodes YE are drawn out. Further, the address electrodes AE are drawn out to the vicinity of an edge part (the circumference part OT on a lower side in FIG. 4) along the first direction D1 of the front plate part 12.

As explained with FIG. 1 described above, the flexible cable YFC for Y electrode, the flexible cable XFC for X electrode and the flexible cable AFC for address electrode are coupling the circuit unit 60 to the PDP 10 electrically. For example, one ends of the flexible cables XFC, YFC, and AFC are coupled to the electrodes XE, YE, and AE, respectively, in the circumference parts OT of the PDP 10, and the other ends of the flexible cables XFC, YFC, and AFC are coupled to the drivers XDRV, YDRV, and ADRV, respectively, inside the circumference of the PDP 10.

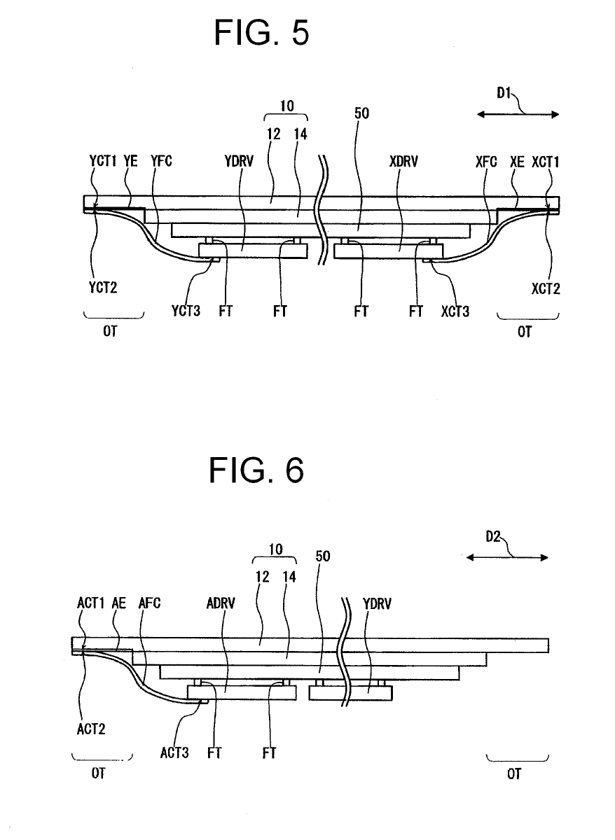

FIG. 5 shows an overview of a side face of the PDP device along the first direction D1 seen from a direction opposite to the side where the address driver ADRV shown in FIG. 4 is disposed. An arrow in the view has the same meaning as in FIG. 2 described above. Incidentally, in FIG. 4, illustrations of the optical filter 20, the front case 30, the rear case 40, and so on shown in FIG. 1 described above are omitted.

Connection parts YCT1 which are end parts of the Y electrodes YE drawn out to the vicinity of the edge part of the front plate part 12 are coupled to connection parts YCT2 provided on one end of the flexible cable YFC for Y electrode. Connection parts YCT3 provided on the other end of the flexible cable YFC for Y electrode are coupled to the Y driver YDRV inside the circumference of the PDP 10 without folding back the flexible cable YFC for Y electrode. Specifically, the flexible cable YFC for Y electrode is arranged with the end part on which the connection parts YCT2 are provided being directed outward, and provided to extend from the connection parts YCT2 to the Y driver YDRV provided inside the PDP 10 without being folded back in a U shape outside the PDP 10 (outside connection parts of the connection parts YCT1 and the connection parts YCT2).

In this embodiment, since the flexible cable YFC for Y electrode is not folded back in a U shape, forces operating on the connection parts YCT1 and the connection parts YCT2 in directions to depart from each other can be reduced, and thereby it is possible to prevent coupling of the connection parts YCT1 and the connection parts YCT2 from becoming unstable (a non-coupled state). Further, in this embodiment, since the flexible cable YFC for Y electrode is not folded back in a U shape, disconnection of the flexible cable YFC for Y electrode can be prevented. In short, in this embodiment, disconnection between the connection parts YCT1 of the Y electrodes YE and the Y driver YDRV can be prevented, and reliability of the PDP device can be improved.

Connection parts XCT1 which are end parts of the X electrodes XE drawn out to the vicinity of the edge part of the front plate part 12 are coupled to connection parts XCT2 provided on one end of the flexible cable XFC for X electrode. Further, connection parts XCT3 provided on the other end of the flexible cable XFC for X electrode are coupled to the X driver XDRV inside the circumference of the PDP 10 without folding back the flexible cable XFC for X electrode.

In this embodiment, since the flexible cable XFC for X electrode is not folded back in a U shape, forces operating on the connection parts XCT1 and the connection parts XCT2 in directions to depart from each other can be reduced, and thereby it is possible to prevent coupling of the connection parts XCT1 and the connection parts XCT2 from becoming unstable (a non-coupled state). Further, in this embodiment, since the flexible cable XFC for X electrode is not folded back in a U shape, disconnection of the flexible cable XFC for X electrode can be prevented. In short, in this embodiment, disconnection between the connection parts XCT1 of the X electrodes XE and the X driver XDRV can be prevented, and reliability of the PDP device can be improved.

Further, when focusing attention to the size of the PDP device, in this embodiment, it is not necessary to secure a thickness for folding back the flexible cables XFC, YFC in a U shape, and thus the thickness of the circumference of the edge parts along the second direction D2 of the PDP device can be reduced. Moreover, in this embodiment, it is not necessary to secure a space for folding back the flexible cables XFC, YFC in a U shape outside the PDP 10, and thus the size of the PDP device (for example, the size in the first direction D1 of the PDP device) can be made small. In short, in this embodiment, since the size of the PDP device can be made small, manufacturing costs of the cases 30, 40, and so on shown in FIG. 1 described above can be reduced.

Incidentally, the drivers XDRV, YDRV are fixed to a back side (lower side in FIG. 5) of the base chassis 50 inside the edge parts of the back plate part 14 with installation members FT (screws for example). Further, the connection parts XTC3, YCT3 are coupled to the drivers XDRV, YDRV with a not shown connector or the like.

FIG. 6 shows an overview of a side face of the PDP device along the second direction D2 seen from a side where the Y driver YDRV shown in FIG. 4 is disposed. An arrow in the view has the same meaning as in FIG. 2 described above. Incidentally, in FIG. 6, illustrations of the optical filter 20, the front case 30, and the rear case 40 shown in FIG. 1 described above and the flexible cable YFC for Y electrode and so on shown in FIG. 4 are omitted.

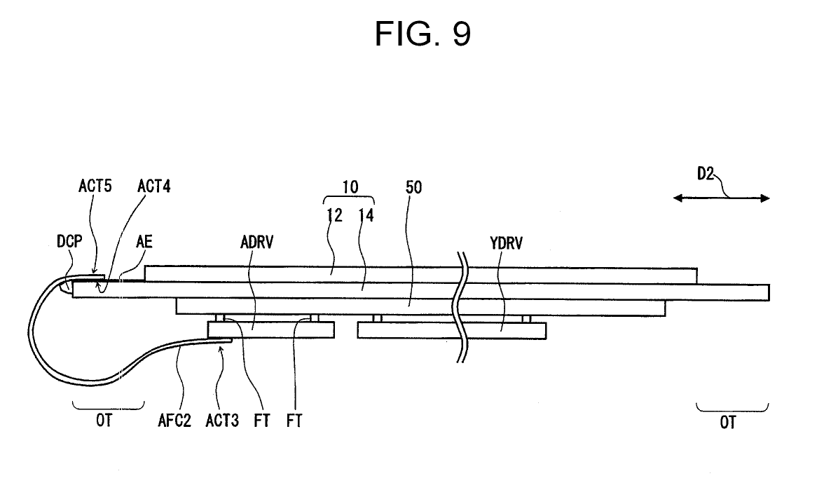

Connection parts ACT1 which are end parts of the address electrodes AE drawn out to the vicinity of the edge part of the front plate part 12 are coupled to connection parts ACT2 provided on one end of the flexible cable AFC for address electrode. Connection parts ACT3 provided on the other end of the flexible cable AFC for address electrode are coupled to the address driver ADRV inside the circumference of the PDP 10 without folding back the flexible cable AFC for address electrode. Specifically, the flexible cable AFC for address electrode is coupled to the address driver ADRV without being folded back at a corner of the back plate part 14. Accordingly, in this embodiment, it is not necessary to provide a disconnection preventing material or the like (for example, a disconnection preventing material DCP shown in FIG. 9 described later) for preventing disconnection of the flexible cable AFC for address electrode at the corner of the back plate part 14. Consequently, in this embodiment, manufacturing costs of the PDP device can be reduced.

Further, in this embodiment, since the flexible cable AFC for address electrode is not folded back in a U shape, forces operating on the connection parts ACT1 and the connection parts ACT2 in directions to depart from each other can be reduced, and thereby it is possible to prevent coupling of the connection parts ACT1 and the connection parts ACT2 from becoming unstable (a non-coupled state). Further, in this embodiment, since the flexible cable AFC for address electrode is not folded back in a U shape, disconnection of the flexible cable AFC for address electrode can be prevented. In short, in this embodiment, disconnection between the connection parts XCT1 of the X electrodes XE and the X driver XDRV can be prevented, and reliability of the PDP device can be improved.

Further, when focusing attention to the size of the PDP device, in this embodiment, it is not necessary to secure a thickness for folding back the flexible cable AFC for address electrode in a U shape, and thus the thickness of the circumference of the edge parts along the first direction D1 of the PDP device can be reduced. Moreover, in this embodiment, it is not necessary to secure a space for folding back the flexible cable AFC for address electrode in a U shape outside the PDP 10, and thus the size of the PDP device (for example, the size in the second direction D2 of the PDP device) can be made small. In short, in this embodiment, since the size of the PDP device can be made small, manufacturing costs of the cases 30, 40, and so on shown in FIG. 1 described above can be reduced.

Incidentally, the address driver ADRV is fixed to the back side (lower side in FIG. 6) of the base chassis 50 inside the edge parts of the back plate part 14 with installation members FT (screws for example). Further, the connection parts ACT3 are coupled to the address driver ADRV with a not shown connector or the like.

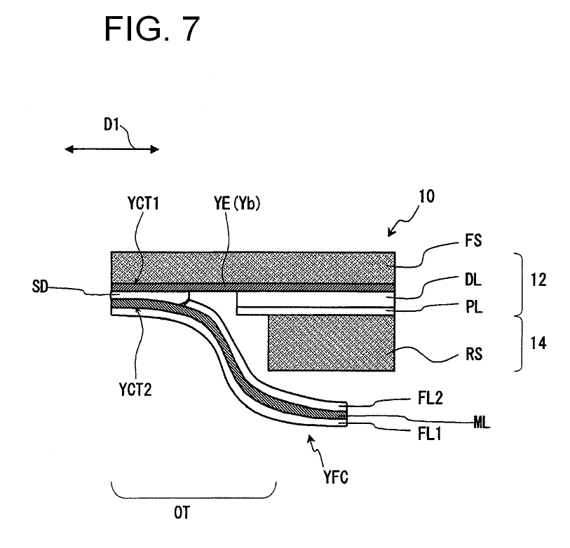

FIG. 7 shows an example of a cross section along the first direction D1 in the vicinity of the connection part of the flexible cable YFC for Y electrode and a Y electrode YE shown in FIG. 5 described above. Incidentally, FIG. 7 shows a cross section of a position where a bus electrode Yb shown in FIG. 2 described above is disposed. An arrow in the view has the same meaning as in FIG. 2 described above.

The flexible cable YFC for Y electrode has, as explained with FIG. 4 described above, a base film FL1, wires ML formed on the base film FL1, and a protective film FL2 covering the wires ML except the connection parts YCT2 (connection parts YCT3 shown in FIG. 5 described above). An end part of the protective film FL2 of the flexible cable YFC for Y electrode on the side of the connection parts YCT2 is located more inside than the connection parts YCT2, so as to expose the connection parts YCT2 to the outside of the flexible cable YFC for Y electrode. Further, the flexible cable YFC for Y electrode is arranged with the end part on which the connection parts YCT2 are provided being directed outward as explained with FIG. 5 described above.

Further, edge parts of the dielectric layer DL, the protective layer PL and the glass base RS on the side of the connection parts YCT1 are located more inside than the connection parts YCT1, so as to expose the connection parts YCT1 to the outside of the PDP 10. The connection parts YCT1 are coupled to the connection parts YCT2 with solders SD or the like. Incidentally, a cross section along the first direction D1 in the vicinity of the connection part of the flexible cable XFC for X electrode and an X electrode XE is substantially the same as the cross section along the first direction D1 in the vicinity of the connection part of the flexible cable YFC for Y electrode and a Y electrode YE.

Moreover, a cross section along the second direction D2 in the vicinity of the connection part of the flexible cable AFC for address electrode and an address electrode AE is substantially the same as the cross section along the first direction D1 in the vicinity of the connection part of the flexible cable YFC for Y electrode and a Y electrode YE. Incidentally, since the connection parts ACT1 of the address electrodes AE are formed on the dielectric layer DL, edge parts of the protective layer PL and the glass base RS on the side of the connection parts ACT1 are located more inside than the connection parts ACT1.

As described above, in this embodiment, the connection parts XCT3, YCT3, and ACT3 of the respective flexible cables XFC, YFC, and AFC are coupled to the respective drivers XDRV, YDRV, and ADRV without folding back the flexible cables XFC, YFC, and AFC. Accordingly, in this embodiment, disconnection between the connection parts XCT1, YCT1, and ACT1 of the respective electrodes XE, YE, and AE and the respective drivers XDRV, YDRV, and ADRV can be prevented, and reliability of the PDP device can be improved. Moreover, in this embodiment, since it is not necessary to secure a thickness or space for folding back the flexible cables XFC, YFC, and AFC, the thickness of the PDP device can be reduced, and the size of the PDP device can be made small. That is, in this embodiment, a thin-type PDP device can be provided. Further, in this embodiment, since the size of the PDP device relative to the PDP 10 can be made small, manufacturing costs can be lowered.

Note that the above-described embodiment has been described with respect to an example in which one pixel is made up of three cells (red (R), green (G), blue (B)). The present invention is not limited to such embodiments. For example, one pixel may be formed of four or more cells. Alternatively, one pixel may be formed of cells producing colors other than red (R), green (G), blue (B), and one pixel may include a cell producing a color other than red (R), green (G), blue (B).

The above-described embodiment has been described with respect to an example in which the second direction D2 is orthogonal to the first direction D1. The present invention is not limited to such embodiments. For example, the second direction D2 may intersect the first direction D1 in a substantially orthogonal direction (for example, 90 degrees ±5 degrees). Also in this case, the same effects as those in the above-described embodiment can be obtained.

The above-described embodiment has been described with respect to an example in which the Y driver YDRV is coupled to the flexible cable YFC for Y electrode with a connector or the like. The present invention is not limited to such embodiments. For example, the Y driver YDRV may be provided integrally with the flexible cable YFC for Y electrode on the base film FL1 of the flexible cable YFC for Y electrode. Similarly, the drivers XDRV, ADRV may be provided integrally with the flexible cables XFC, AFC, respectively, on the base film FL1 of the flexible cables XFC, AFC.

In this case, the PDP device has, for example, a flexible printed circuit board on which the Y driver YDRV and the flexible cable YFC for Y electrode are provided integrally. Incidentally, an end part of the flexible printed circuit board on which the Y driver YDRV is not provided is an end part (one end of the flexible cable) on which the connection parts YCT2 of the flexible cable YFC for Y electrode shown in FIG. 5 described above are provided. Connection parts of the Y driver YDRV of the flexible printed circuit board and the wires ML of the flexible cable YFC for Y electrode correspond to the connection parts YCT3 of the flexible cable YFC for Y electrode shown in FIG. 5. Also in this case, the same effects as those in the above-described embodiment can be obtained.

The above-described embodiment has been described with respect to an example in which the connection parts ACT1 of the address electrodes AE are provided in the vicinity of one edge part (the circumference part OT on the left side in FIG. 6 described above) out of two edge parts along the first direction D1 of the front plate part 12. The present invention is not limited to such embodiments. For example, the connection parts ACT1 of the address electrodes AE may be provided in the vicinities of both the edge parts (the left and right circumference parts OT in FIG. 6) along the first direction D1 of the front plate part 12. Alternatively, the address electrodes AE on which the connection parts ACT1 are provided in the vicinity of the one edge part and the address electrodes AE on which the connection parts ACT1 are provided in the vicinity of the other edge part may be mixed. Also in this case, the same effects as those in the above-described embodiment can be obtained.

The above-described embodiment has been described with respect to an example in which the X driver XDRV applies the voltages −Vs/2, Vs/2 alternately to the X electrodes XE. The present invention is not limited to such embodiments. For example, the X electrodes XE may be kept at ground voltage GND. In this case, for example, the Y driver YDRV applies the voltages Vs, −Vs alternately to the Y electrodes YE in the sustain period. In a PDP device in which the X electrodes XE are kept at the ground voltage GND, the X driver XDRV and the flexible cable XFC for X electrode may be omitted from the structure shown in FIG. 4 described above. In this case, the ground voltage GND is supplied from a ground line or the like of the PDP 10 to the X electrodes XE.

Specifically, the PDP device has a first driver circuit (for example, the Y driver YDRV) driving first electrodes as one electrodes out of electrodes XE, YE (for example, the Y electrodes YE), and a first flexible cable (for example, the flexible cable YFC for Y electrode) coupling the first electrodes to the first driver circuit electrically. Incidentally, the first flexible cable (for example, the flexible cable YFC for Y electrode) is coupled to the first driver circuit (for example, the Y driver YDRV) without being folded back as explained in the above-described embodiment. Also in this case, the same effects as those in the above-described embodiment can be obtained.

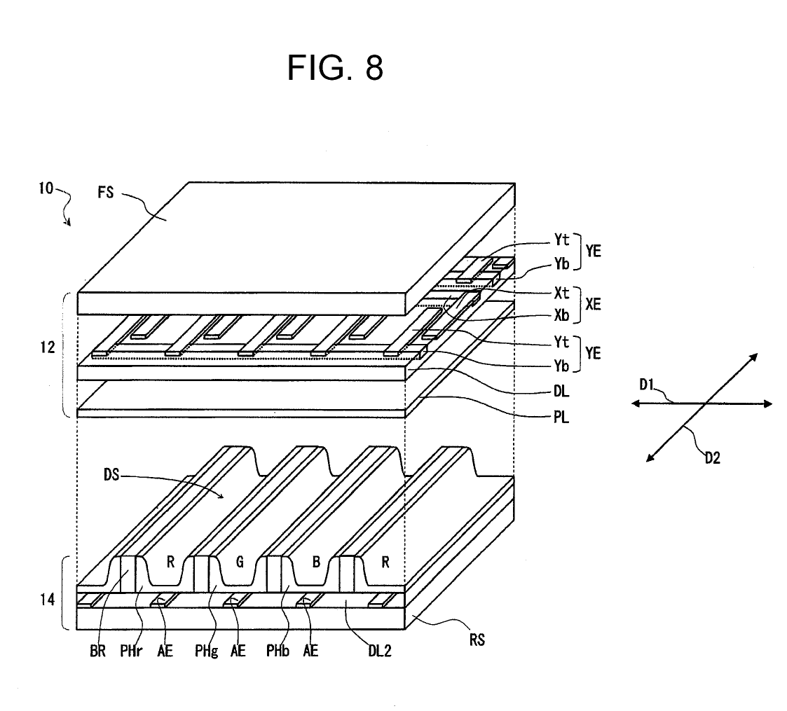

The above-described embodiment has been described with respect to an example in which the address electrodes AE are provided on the front plate part 12. The present invention is not limited to such embodiments. For example, as shown in FIG. 8, the address electrodes AE may be provided on the back plate part 14. FIG. 8 shows an example of a modification of the PDP 10 shown in FIG. 2 described above. Arrows in the view have the same meaning as in FIG. 2 described above. In the structure of FIG. 8, the plurality of address electrodes AE extending in the second direction D2 are provided on a plane of the glass base RS that faces the glass base FS, and is covered with a dielectric layer DL2. Barrier ribs BR are then formed on the dielectric layer DL2. In this case, as shown in FIG. 9, a flexible cable AFC2 for address electrode is folded back in a U shape outside the circumference of the PDP 10 and coupled to the address driver ADRV.

FIG. 9 shows an overview of a side face along the second direction D2 in a PDP device using the PDP 10 shown in FIG. 8. An arrow in the view has the same meaning as in FIG. 2 described above. Incidentally, in FIG. 9, illustrations of the optical filter 20, the front case 30, and the rear case 40 shown in FIG. 1 described above and the flexible cable YFC for Y electrode and so on shown in FIG. 4 described above are omitted. The structure in FIG. 9 is the same as that in the FIG. 6 described above except the structure in the vicinity of end parts of the address electrodes AE. That is, the structure of a surrounding part of the flexible cables XFC, YFC is the same as that in FIG. 4, FIG. 5, and FIG. 7 described above.

Connection parts ACT4 which are end parts of the address electrodes AE drawn out to the vicinity of the edge part (circumference part OT) of the back plate part 14 are coupled to connection parts ACTS provided on one end of the flexible cable AFC2 for address electrode. Incidentally, for example, the flexible cable AFC2 for address electrode is arranged with the end part coupled to the address electrodes AE being directed toward an inner peripheral side of the PDP 10 because the address electrodes AE are provided on the back plate part 14 (more specifically, on the glass base RS). Accordingly, connection parts ACT3 provided on the other side of the flexible cable AFC2 for address electrode are coupled to the address driver ADRV with the flexible cable AFC2 for address electrode being folded back in a U shape outside the circumference of the PDP 10.

Further, between the flexible cable AFC2 for address electrode and a side face of the back plate part 14, a disconnection preventing material DCP (for example, silicone) is provided so as to prevent the flexible cable AFC2 for address electrode from being disconnected at a corner of the back plate part 14. Incidentally, an edge part of the front plate part 12 on the side of the connection parts ACT4 is located more inside than the connection parts ACT4 so as to expose the connection parts ACT4 to the outside of the PDP 10. In other words, an edge part of the back plate part 14 on the side of the connection parts ACT4 is located more outside than the edge part of the front plate part 12. Incidentally, an edge part of the back plate part 14 on which the connection parts ACT4 are not provided may be at the same position as an edge part of the front plate part 12.

Also in the structure of FIG. 9 (FIG. 8), for example, the connection parts XCT3, YCT3 of the respective flexible cables XFC, YFC are coupled to the respective drivers XDRV, YDRV without folding back the flexible cables XFC, YFC. Thus, disconnection between the connection parts XCT1, YCT1 of the respective electrodes XE, YE and the respective drivers XDRV, YDRV is prevented, and reliability of the PDP device improves. Further, also in this case, the thickness in the vicinity of the edge part along the second direction D2 of the PDP device can be reduced, and the size of the PDP device (for example, the size in the first direction D1 of the PDP device) can be made small. Specifically, also in this case, the same effects as those in the above-described embodiment can be obtained except the effect by the flexible cable AFC for address electrode of the above-described embodiment.

In the foregoing, the present invention has been described in detail, but the above-described embodiment and modification examples thereof are merely examples of the present invention, and the present invention is not limited to them. It is obvious that the present invention can be modified within a range not departing from the invention.

### INDUSTRIAL APPLICABILITY

The present invention can be applied to a plasma display device.

1. A plasma display device, comprising:
a plasma display panel having a first plate on which a plurality of first and second electrodes extending in a first direction are provided and a second plate facing the first plate via a discharge space;
a first driver circuit which applies a voltage to the first electrodes; and
a first flexible cable having one end coupled to the first electrodes in a circumference part of the plasma display panel, wherein
the other end of the first flexible cable is coupled to the first driver circuit inside a circumference of the plasma display panel without folding back the first flexible cable.

2. The plasma display device according to claim 1, further comprising:
a second driver circuit which applies a voltage to the second electrodes; and
a second flexible cable having one end coupled to the second electrodes in the circumference part of the plasma display panel, wherein
the other end of the second flexible cable is coupled to the second driver circuit inside the circumference of the plasma display panel without folding back the second flexible cable.

3. The plasma display device according to claim 1, further comprising:
a plurality of third electrodes provided on the first plate and extending in a second direction intersecting the first direction;
a third driver circuit which applies a voltage to the third electrodes; and
a third flexible cable having one end coupled to the third electrodes in the circumference part of the plasma display panel, wherein
the other end of the third flexible cable is coupled to the third driver circuit inside the circumference of the plasma display panel without folding back the third flexible cable.

4. The plasma display device according to claim 1, further comprising
a flexible printed circuit board on which the first driver circuit and the first flexible cable are provided integrally.
